(19) United States
(12) Patent Application Publication
(10) Pub. No.: US 2026/0093671 A1
(43) Pub. Date: Apr. 2, 2026

(54) DATABASE ARCHITECTURE FOR DATABASE RULES GENERATION

(71) Applicant: ZenPayroll, Inc., San Francisco, CA (US)

(72) Inventors: Matan Zruya, San Francisco, CA (US); Jeff Carbonella, Denver, CO (US)

(21) Appl. No.: 18/903,340

(22) Filed: Oct. 1, 2024

(51) Int. Cl. G06F 16/21; G06F 16/22

(52) U.S. Cl. CPC G06F 16/213; G06F 16/219; G06F 16/2282

(57) ABSTRACT

A database system includes a rules database, an interaction engine, and an update engine. The rules database stores multiple data tables, each corresponding to a jurisdiction and an action type. The interaction engine is configured to perform a network action with a remote server associated with a target jurisdiction and a target action type, generates computer code required to perform the network action based on data types included within the target data table, and transmits the generated computer code to the remote server to perform the network action. The update engine is configured to modify the data tables stored in the rules database.

### BACKGROUND

This disclosure relates generally to database systems and, more specifically, to dynamically updating databases to support network actions across various action types.

Centralized database systems, such as employment management database systems, store large amounts of data for the various entities associated with the database systems. In some embodiments, this data includes comprehensive employee data, such as personal information, tax codes, salaries, and wage rates. Such an employment management database system may also be configured to compute detections for taxes, social security, health insurance, retirement contributions, and other voluntary or mandatory deductions to determine net pay. In some embodiments, the employment management database system may also be configured to help ensure compliance with tax laws and employment legislation by maintaining records and generating necessary reports for government agencies.

Notably, tax laws and employment regulations are subject to frequent changes. Each time the laws are amended, engineers are often required to update the software to remain compliant manually. This may include manually inputting new tax rates and regulations into the system. Moreover, when relying on third-party software components, the entities have to wait for the software vendors to release updates, potentially delaying compliance.

### SUMMARY

Embodiments described herein relate to a database system that includes a rules database, an interaction engine, and an update engine. The rules database includes a non-transitory computer-readable storage medium storing a plurality of data tables. Each data table corresponds to a jurisdiction and an action type. Each data table defines a plurality of data types and corresponding data formats to satisfy requirements of the action type.

The interaction engine includes at least a hardware processor configured to perform one or more computer actions by receiving a request to perform a network action with a remote server associated with a target jurisdiction and a target action type. The interaction engine accesses a target data table associated with the target jurisdiction and the target action type and generates computer code required to perform the network action based on the plurality of data types and corresponding data formats included within the target data table. The interaction engine transmits the generated computer code to the remote server to perform the network action.

The update engine is configured to modify the rules database by receiving, via an interface, an identified jurisdiction, an identified action type, an identified data type, and corresponding identified data formats. The update engine determines whether the rules database includes a data table corresponding to the identified jurisdiction and the identified action type. In response to the rules database including a data table corresponding to the identified jurisdiction and the identified action type, the rule update engine modifies the data table to include the identified data types and corresponding identified data formats. In response to the rules database not including the data table corresponding to the identified jurisdiction and identified action type, the update engine generates a new data table corresponding to the identified jurisdiction and identified action type including the identified data types and corresponding identified data formats, and stores the generated new data type in the rules database.

### BRIEF DESCRIPTION OF THE DRAWINGS

FIG. 1 is a block diagram of a system environment in which a codebase system operates, in accordance with one or more embodiments.

FIG. 2 is a block diagram of a central database system in accordance with one or more embodiments.

FIG. 3 illustrates an example process of applying a rule and a schema to entity data to submit a tax payment to a remote server associated with an ACH network in accordance with one or more embodiments.

FIG. 4 illustrates an example process for applying a rule and a schema to entity data to submit a filing to a remote server in accordance with one or more embodiments.

FIG. 5 illustrates an example graphical user interface (GUI) displaying a set of rules stored in a rules database in accordance with one or more embodiments.

FIG. 6 illustrates an example GUI displaying a specific rule (e.g., IL withholding rule) stored in a rules database in accordance with one or more embodiments.

FIG. 7 illustrates an example GUI displaying a set of rules that are applied to a specific entity in accordance with one or more embodiments.

FIG. 8 illustrates an example GUI displaying rules specific to one jurisdiction that are applied to a specific entity in accordance with one or more embodiments.

FIG. 9 illustrates an example GUI displaying a set of TXP code schemas stored in a schema database in accordance with one or more embodiments.

FIG. 10 illustrates an example GUI displaying a TXP record generated by applying a specific rule and a specific TXP record schema to data of an entity in accordance with one or more embodiments.

FIG. 11 illustrates an example GUI displaying a set of form schema stored in a schema database in accordance with one or more embodiments.

FIG. 12 illustrates an example GUI displaying a field of a form schema that may be modified in accordance with one or more embodiments.

FIG. 13 illustrates an example GUI displaying a set of filing schema stored in a schema database in accordance with one or more embodiments.

FIG. 14 illustrates an example GUI displaying different versions of a rule in accordance with one or more embodiments.

FIG. 15 illustrates an example GUI displaying different versions of a schema in accordance with one or more embodiments.

FIG. 16 is a flowchart of an example method for performing a network action with a remote server associated with a target jurisdiction and a target action type in accordance with one or more embodiments.

FIG. 17 is a flowchart of an example method for updating a rule database that stores data tables associated with a plurality of jurisdictions and corresponding action types in accordance with one or more embodiments.

FIG. 18 is a flowchart of an example method for performing network action with a remote server in accordance with one or more embodiments.

FIG. 19 is a block diagram of an example computer suitable for use in the networked computing environment of FIG. 1.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

An employment management database system may be configured to store comprehensive employee data, such as personal information, tax codes, salaries, and wage rates. The system may also record employees'working hours, overtime, leaves, absences, and vacations to determine gross pay. In some embodiments, the system may also compute deductions for taxes, social security, health insurance, retirement contributions, and other voluntary or mandatory deductions to determine net pay. The system can also produce various pay slips for employees and various reports for management, such as payroll summaries, tax reports, and contribution reports. Additionally, the system may help ensure compliance with tax laws and employment legislation by maintaining records, making payments and generating reports for filing with government agencies. Notably, tax laws and employment regulations are subject to frequent changes, conventionally, each time the laws are amended, relevant software of the system is manually updated to reflect the change. This challenge is compounded by the requirement to make payments and report filings in compliance with these ever-changing rules across many tax agencies in different jurisdictions and for many different entities.

Embodiments described herein solve this problem of tracking and responding to constant changes in laws and rules by separating the rules from an interaction engine. The rules are stored in a rules database, and the interaction engine is configured to interpret and apply these rules to different entities'data to orchestrate payments and document filings. This bifurcation allows for dynamic updates to the rules database without the need to overhaul the interaction engine, thereby facilitating a more efficient, accurate, and adaptable database system.

In some embodiments, the database system may also include an update engine configured to generate and/or update rules stored in the rules database. When a rule of a jurisdiction changes, the update engine is configured to update the rule stored in the rules database. Upon a rule update, the interaction engine automatically applies the updated rule to all entities'data impacted by the rule update.

### System Architecture

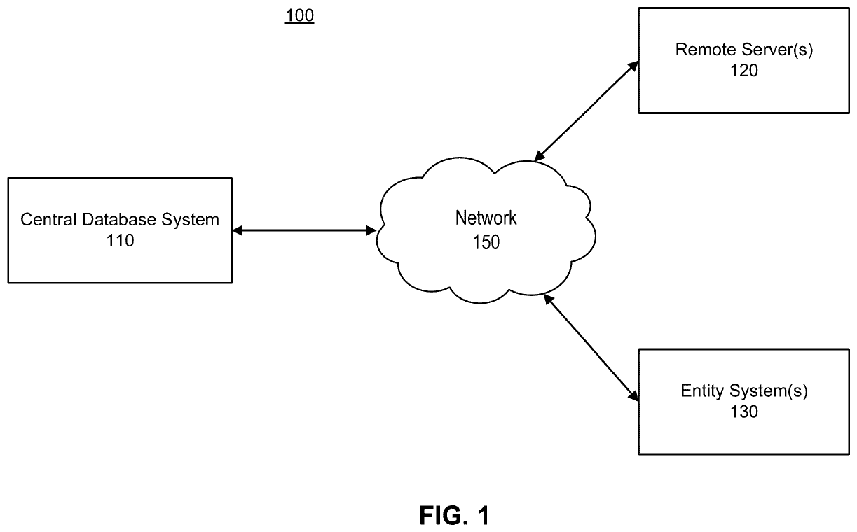

FIG. 1 is a block diagram of a system environment 100 in which a database system 110 operates, in accordance with one or more embodiments. The system environment 100 shown by FIG. 1 includes a central database system 110, one or more remote servers 120, one or more entity systems 130, and a network 150. The system environment 100 may have alternative configurations than shown in FIG. 1, including, for example, different, fewer, or additional components.

The central database system 110 is, in some embodiments, a human resources management system configured to receive and store information associated with one or more entities, corresponding to the one or more entity systems 130. Each entity may be an institution (e.g., a corporation, a partnership, a law firm, an educational institution, an organization, etc.) that employs and/or associates with one or more individuals. The central database system 110 stores information describing these individuals as well as relationships between the individuals and each of the entities. For example, the central database system 110 may include information about an individual's hiring date, employment level, position, title, geographic information, salary, benefits, tax status, contact information, and so on. The central database system 110 receives and stores characteristics describing the entities from the entity systems 130. Characteristics include, for example, information relating to an entity's size, type, industry, tax status, domicile, incorporation and/or formation, management personnel, and customer base, as well as actions performed by the entities or by individuals associated with the entities, resources used by the entities or individuals associated with the entities, and issues encountered by the entities or individuals associated with the entities.

The remote servers 120 may be servers associated with various financial institutions for receiving tax payments from entities and/or servers associated with jurisdictions for receiving filings from entities. At least some of the remote servers 120 allow for electronic submission of various tax forms and documents, catering to different types of taxes such as (but not limited to) income, sales, payroll, and corporate taxes. At least some of the remote servers 120 facilitate electronic payment of taxes via methods like direct bank transfers, credit/debit cards, and/or digital wallets. In some embodiments, upon receiving filings or payments, the remote servers 120 perform automatic checks to validate the received filing or payment against predefined rules and formats. In some embodiments, the remote servers 120 automatically update tax records of an entity stored in government databases responsive to receiving submissions of documents and/or payments.

In some embodiments, the central database system 110 is configured to interact with the remote servers 120 via the network 150. In some embodiments, the central database system 110 is configured to generate filings and determine a payment amount for an entity, and perform submission of filing and/or payment on behalf of the entity. Alternatively, in some embodiments, the central database system 110 is configured to send the generated filings and determined payment amount to an entity system and cause the entity systems 130 to perform the submission of filing and/or payment themselves.

In some embodiments, the central database system 110 includes a rules database and an interaction engine. The rules database stores a plurality of data tables, each corresponding to a jurisdiction and an action type. Each data table defines a plurality of data types and corresponding data formats to satisfy requirements of the action type.

In some embodiments, an action type may include computing and submitting a payment of a particular amount (e.g., federal income tax withholding, social security and medicare taxes, state income taxes withholding) to a remote server 120 associated with a particular jurisdiction. A data type may include various parts of a code required for the jurisdiction for receiving electronic payments. For example, in Automated Clearing House (ACH) transactions for transmitting taxpayer information and payments to tax authorities, a tax payment (TXP) code is required to be sent with each payment. The TXP code is integrated into the ACH transaction's addenda records. This allows detailed tax payment information to accompany the electronic transfer of funds. The addenda record contains structured data that specifies the type of tax, the tax period, and other relevant details necessary for the tax authority to correctly apply the payment. The TXP code follows a structured format that includes pieces of data, such as (but not limited to) a taxpayer identification number, a tax form code, a tax period, and an amount of payment. For example, a business needs to make a quarterly state income tax payment, the payment details might be structured in a code as follows:
TXP*123456789*2023Q1*1120*15000.00.

In this code, TXP indicates that this is a tax payment record; 123456789 indicates the taxpayer's identification number (e.g., EIN), 2023Q1 indicates a tax period the payment is being made for, 1120 indicates a type of tax or a specific tax form being submitted with the payment of the type of tax (e.g., “1120” could hypothetically represent a specific state income tax form for corporations), and 15000.00 indicates a dollar amount of the tax payment. Notably, the TXP formats can vary based on the requirements of the jurisdictions receiving the payment and the specific details of the tax being paid.

In some embodiments, an action type may include generating and submitting a particular filing document (e.g., W-2 form, W-4 form, 1099 form, etc.) to a remote server 120 associated with a particular jurisdiction. A data type may include a particular parameter (e.g., employer identification number, federal income tax withheld, etc.) corresponding to a particular field in the filing document.

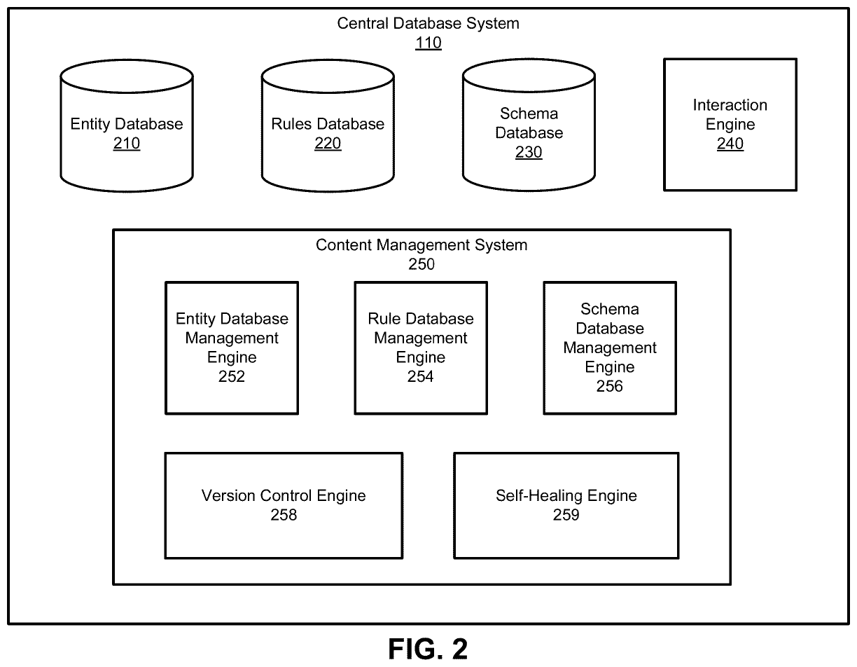

The central database system 110 stores the filing and payment requirements in a rules database. The interaction engine of the central database system 110 is configured to apply the rules in the rules database to entity data to generate filing documents and compute payment amounts. Additional details about the database system 110 are further described below with respect to FIGS. 2-18.

The central database system 110 may be a server, server group or cluster (including remote servers), or other suitable computing device or system of devices. The central database system 110 may include applications configured to communicate with other devices, including those associated with the entity systems 130, via client devices over the network 150 to receive and send information about individuals and entities. Examples of client devices include conventional computer systems (such as a desktop or a laptop computer, a server, a cloud computing device, and the like), mobile computing devices (such as smartphones, tablet computers, mobile devices, and the like), or any other device having computer functionality. The devices of the entity systems 130 and the central database system 110 are configured to communicate via the network 150, for example, using a native application executed by the devices or through an application programming interface (API) running on a native operating system of the devices, such as IOS® or ANDROID™. In another example, the devices of the entity systems 130, and the central database system 110 communicate via applications or APIs running on the central database system.

The central database system 110, the remote server 120, and the entities systems 130 are configured to communicate via the network 150, which may comprise any combination of local area and/or wide area networks, using wired and/or wireless communication systems. In one embodiment, the network 150 uses standard communications technologies and/or protocols. For example, the network 150 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 150 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 150 may be represented using any suitable format, such as hypertext markup language (HTML) or extensible markup language (XML). In some embodiments, all or some of the communication links of the network 150 may be encrypted using any suitable technique or techniques.

### Example Architecture of Central Database System

FIG. 2 is a block diagram of a central database system 110 in accordance with one or more embodiments. The central database system 110 includes an entity database 210, a rules database 220, a schema database 230, an interaction engine 240, and a content management system 250. The central database system 110 may have alternative configurations than shown in FIG. 2, including, for example, different, fewer, or additional components.

The entity database 210 stores employee-related data within each entity. Such data may include (but is not limited to) employee name, address, contact information, social security number (SSN), date of birth, gender, employee ID, hire date, position/title, department, manager/supervisor, employment type, work location, work schedule, salary/wages, payroll information (e.g., bank account details for direct deposit, tax withholdings, and pay frequency), benefits enrollment, time off, performance reviews, training and development records, career progression, right to work documentation, safety training and compliance records, disciplinary records, recognition and awards, among others. The entity database 210 also stores information related to the entities, such as taxpayer identification, e.g., the corporation's employer identification number (EIN) or taxpayer identification number (TIN), which is used by jurisdictions to identify the entity.

The rules database 220 stores tax and/or employment rules related to various jurisdictions. Such data includes (but is not limited to) formulas for computing various state and federal income tax and state unemployment insurance (SUI). For example, income tax is often related to taxable income and credit, and taxable income is related to gross income, adjustments, deductions and exemptions, etc. Each jurisdiction has its own formula and rules for determining a tax amount for a given set of relevant entity data. As such, the rules database 220 stores rules that are applicable to entity data stored in the entity database 210, although it does not contain data specific to entities.

The schema database 230 stores schemas of filing documents or payment code that are more specific to rules. For example, based on a jurisdiction's rule, a particular form containing a particular set of data (employee name, needs to be submitted to a remote server 120 associated with the jurisdiction. For example, assuming a particular form is a W-2 form in PDF format, the schema of the W-2 form may include a set of fields, such as employer identification number (EIN), employer's name, address, and ZIP code, employee's social security number (SSN), employee's name, address, and ZIP code, Box 1: wages, tips, other compensation, Box 2: federal income tax withheld, Box 3: social security wages, Box 4: social security tax withheld, Box 5: Medicare wages and tips, Box 6: Medicare tax withheld, among others. Each field corresponds to a specific field position and size, field format, static or dynamic content, logical order of field, field properties, etc. Each field in the form is placed at a specific location on the page, with a defined size that accommodates the expected input. For instance, a field for an SSN might be shorter than a field for entering an address. Fields can also be formatted to accept data (e.g., numerical, date, alphanumerical, etc.) in a particular way. For example, date fields might be formatted to ensure that dates (e.g., YYMMDD) are entered consistently. Fields in a form can also have various properties defined, such as whether a field is required, read-only, or hidden until a certain condition is met.

In some embodiments, the schema database 230 also stores TXP code schema for various jurisdictions. As described above, the TXP code is attached to ACH transactions for tax payment. Each jurisdiction may have their own specific format requirements. A typical TXP code schema in an ACH addenda record might include segments for (1) taxpayer identification, (2) tax form code, (3) tax period in a specific format, (4) amount of payment, and/or (5) additional details. Each segment corresponds to a data field and its corresponding format. A TXP code schema may be TXP*TaxpayerID*TaxFormCode*TaxPeriod*Amount.

For example, the central database system 110 applies a rule in the rules database 220 to a set of entity data stored in the entity database 210 to identify a set of data associated with a filing (e.g., W-4 form) required by a jurisdiction, and/or determine an amount of payment (e.g., quarterly tax withhold) to be paid to a jurisdiction. Based on the identified set of data and/or the determined amount of payment, the central database system 110 applies a schema (e.g., a W-4 schema) stored in the schema database 230 to generate a filing document (e.g., a W-4 form) or a TXP code, and transmit the generated filing document and/or make a payment accompanied by the TXP code to a remote server 120 associated with the jurisdiction.

The content management system 250 enables creating, managing, and publishing data stored in entity database 210, rules database 220, and/or schema database 230. In some embodiments, the content management system 250 includes an entity database management engine 252, a rules database management engine 254, a schema database management engine 256, a version control engine 258, and/or a self-healing engine 259. The content management system 250 may have alternative configurations than shown in FIG. 2, including, for example, different, fewer, or additional components.

The entity database management engine 252 enables entities to manage their own employee data, initiate tax filings and/or payments based on their own employee data. The rules database management engine 254 enables update and/or creation of rules responsive to jurisdictions'rule changes. In some embodiments, the rules database management engine 254 only enables its access to qualified professionals who are competent in interpreting tax and employment laws and regulations. In some embodiments, the rules database management engine 254 is configured to communicate with remote servers 120 associated with jurisdictions and directly obtain rule update from the remote servers 120. The schema database management engine 256 enables update and/or creation of schemas, which may be triggered by a rule change or an entity's specific request. In some embodiments, entities can customize or create their own schemas. Alternatively, the entities can also use existing schemas created in compliance with the rules.

The version control engine 258 keeps a history of changes made to entity data stored in the entity database 210, rules stored in the rules database 220, and/or schemas stored in the schema database 230. For example, when a rule is changed, the version control engine 258 records what changes are made, who made the changes, and when they were made. As such, the version control engine 258 tracks a history of rule changes that evolved over time. In some embodiments, the version control engine 258 also allows a rollback of a rule version when bugs are detected in a new version of the rule.

The self-healing engine 259 is configured to automatically detect and correct errors or discrepancies in tax filings and payments without manual intervention, in particular when changes occur in rules. The self-healing engine 259 continuously monitors for changes in rules recorded by the version control engine 258, which could be caused by an update in the entity database 210, the rules database 220, or the schema database 230, or a correction to previous mistakenly performed actions, e.g., filing of wrong forms or submission of a wrong payment. In some embodiments, upon detecting a change or error, the self-healing engine 259 automatically generates a corrective action, e.g., a correction form, or a corrected payment, and causes the new action to be performed.

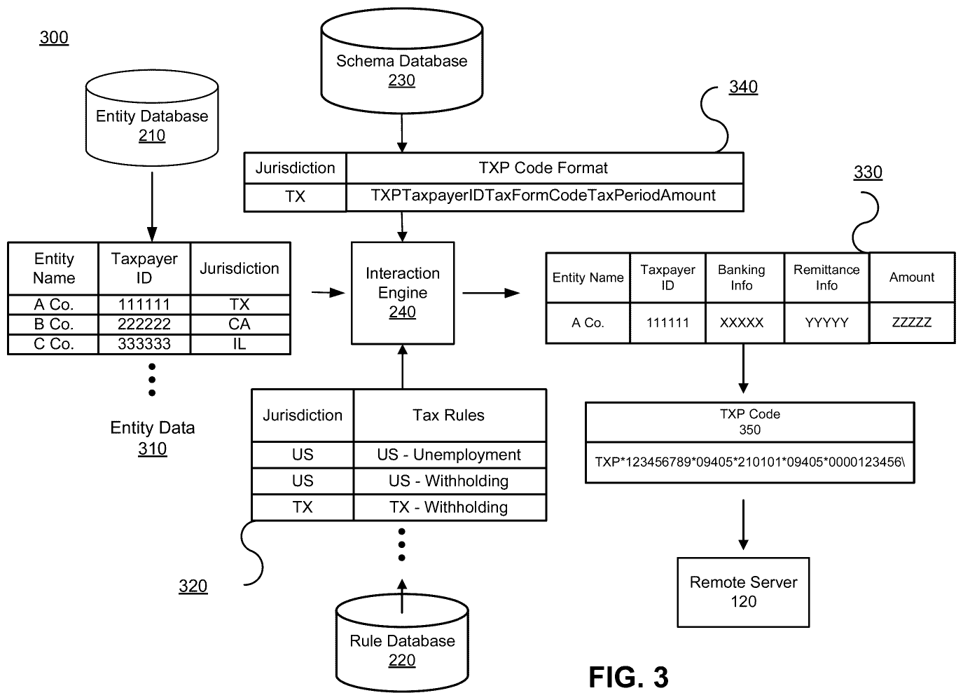

FIG. 3 illustrates an example process 300 of applying a rule and a schema to entity data to submit a tax payment to a remote server associated with the ACH network in accordance with one or more embodiments. As illustrated, entity database 210 includes data associated with different entities, including entity names, taxpayer IDs, and jurisdictions in which the entities are located or regulated. For example, A co. is associated with a taxpayer ID 111111, and it is located in the state of Texas (TX).

The rules database 220 includes tax rules for various jurisdictions, such as US/state unemployment rules and US/state tax withholding rules. Schema database 230 includes schema related to TXP code format for each jurisdiction. The interaction engine 240 has access to data in each of the entity database 210, rules database 220, and schema database 230. For each entity in the entity database, the interaction engine 240 identifies one or more rules 320 in the rules database 220 that are applicable to the entity and applies the identified rules 320 to the entity data 310. For example, for entity, A Co. located in TX, US and TX unemployment and withholding rules are applicable. The interaction engine 240 applies each of the US and TX unemployment and withholding rules to data related to A Co. to extract a set of data 330 that are required for submitting a tax payment for the corresponding jurisdiction. Data related to A Co. includes employee-related data, such as the employee's gross income, adjustments, deductions, etc. The set of data 330 includes an amount of the tax payment to be withheld and submitted to the corresponding jurisdiction.

In some embodiments, the interaction engine 240 calculates the amount of tax payment to be withheld for each employee based on the rule, and calculates a total amount of taxes to be withheld for all the employees. Once the set of data is extracted, the interaction engine 240 identifies a TXP schema 340 from the schema database 230 that is applicable to the set of data 330, and applies the schema 340 to the set of data 330 to generate a TXP code 350. The amount of tax payment with the TXP code 350 is then submitted to a remote server 120, which may be a server of a financial institution within an ACH network.

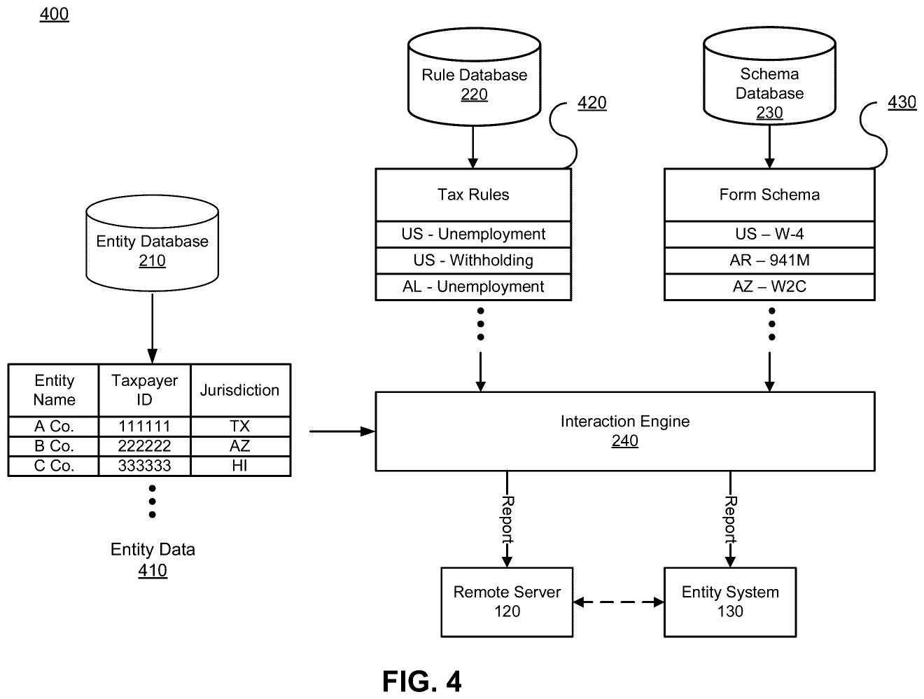

FIG. 4 illustrates an example process 400 for applying a rule and a schema to entity data to submit a filing to a remote server in accordance with one or more embodiments. Similar to the process illustrated in FIG. 3, the interaction engine 240 has access to data contained in the entity database 210, rules database 220, and schema database 230. Entity database 210 includes entity data 410. For each entity, the interaction engine 240 identifies one or more tax rules 420 from the rules database 220 and applies the identified one or more tax rules 420 to the relevant entity data to extract or compute a set of data of the entity that is to be used for a filing. The interaction engine 240 also identifies one or more schemas 430 from the schema database 230 that are relevant to the filing, and applies the identified schemas to the set of data of the entity to generate one or more filing documents, e.g., W-4 form in a particular format (e.g., PDF format), and transmits the filing document to a remote server 120 associated with the corresponding jurisdiction, and/or to an entity system 130 associated with the entity. In some embodiments, the interaction engine 240 can send the filing document to the remote server 120 associated with the jurisdiction directly or causes the entity system 130 to send the filing document to the remote server 120.

### Example GUIs

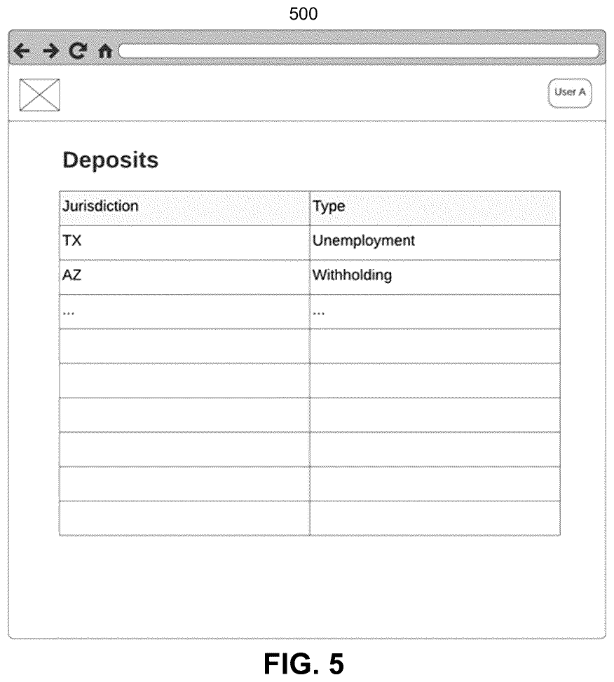

FIG. 5 illustrates an example graphical user interface (GUI) 500 displaying a set of rules stored in a rules database in accordance with one or more embodiments. In some embodiments, users are able to click a particular rule to review or edit that particular rule.

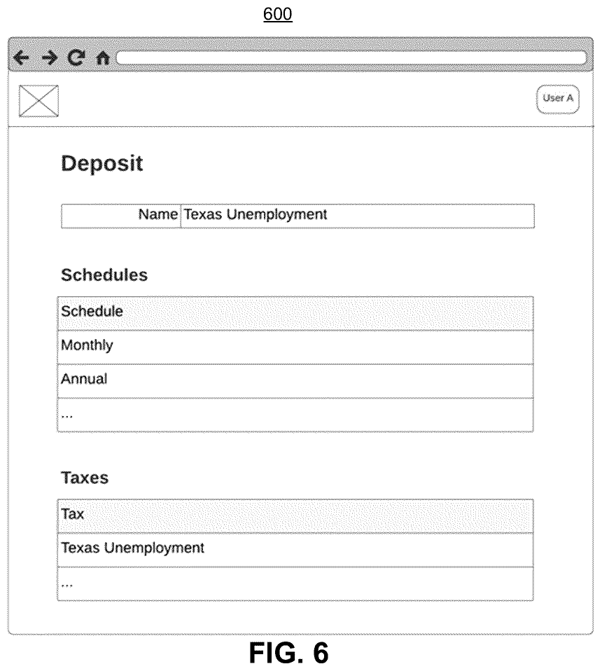

FIG. 6 illustrates an example of GUI 600 displaying a specific rule (e.g., Illinois (IL) withholding rule) in accordance with one or more embodiments. This GUI 600 may be reached by clicking a specific rule displayed in GUI 500. As illustrated, the IL withholding rule includes two payment schedules, namely monthly and semi-weekly, which can be selected by a given entity. Further, the IL withholding rule also includes two tax items, namely IL small business jobs creation tax credit (which is a tax credit), and a state income tax (which is a tax payment).

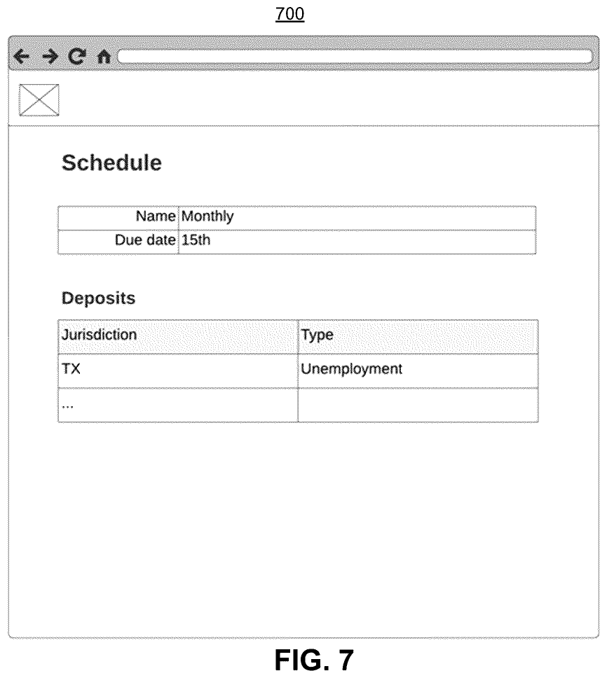

FIG. 7 illustrates an example GUI 700 displaying a set of rules that are applied to a specific entity in accordance with one or more embodiments. The entity may set its tax schedule as monthly, and the entity is subject to multiple jurisdictions'tax rules. All these rules that correspond to a monthly payment schedule are listed on the GUI 700, and a user at the entity may click any one of the tax rules to see additional details about the rule.

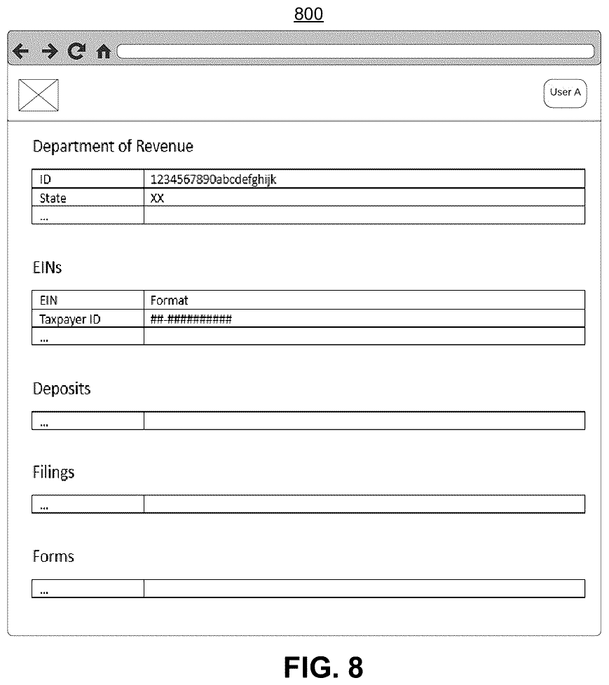

FIG. 8 illustrates an example GUI 800 displaying rules specific to one jurisdiction that are applied to a specific entity in accordance with one or more embodiments. This GUI 800 may be reached by clicking a specific rule displayed in GUI 700. As illustrated, the rule, when applied to a specific entity, requires an IL taxpayer ID, an IL withholding account number, an IL withholding deposit (which is a tax payment), and two filings (e.g., IL W2 and IL withholding filing).

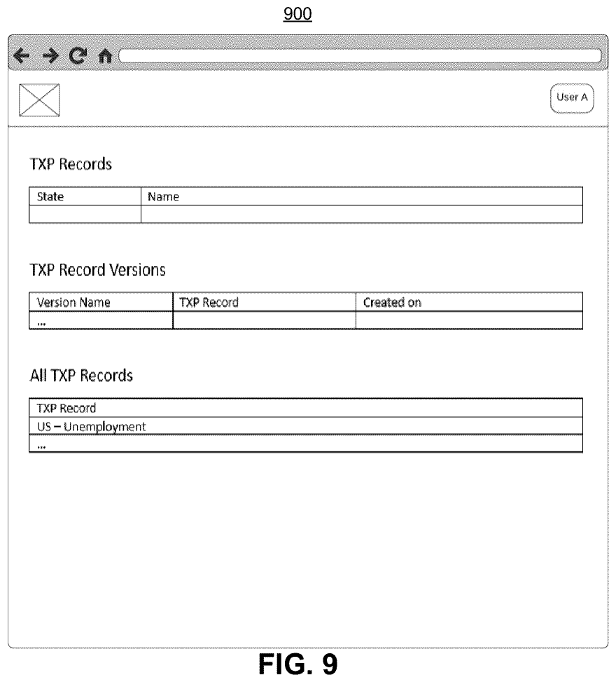

FIG. 9 illustrates an example GUI 900 displaying a set of TXP code schemas stored in a schema database in accordance with one or more embodiments. There are unreleased versions of schemas and released versions of schemas. The unreleased versions might be the ones that are undergoing changes due to a rule change or a request of an entity. Once the schema is released, they can be applied to entity data.

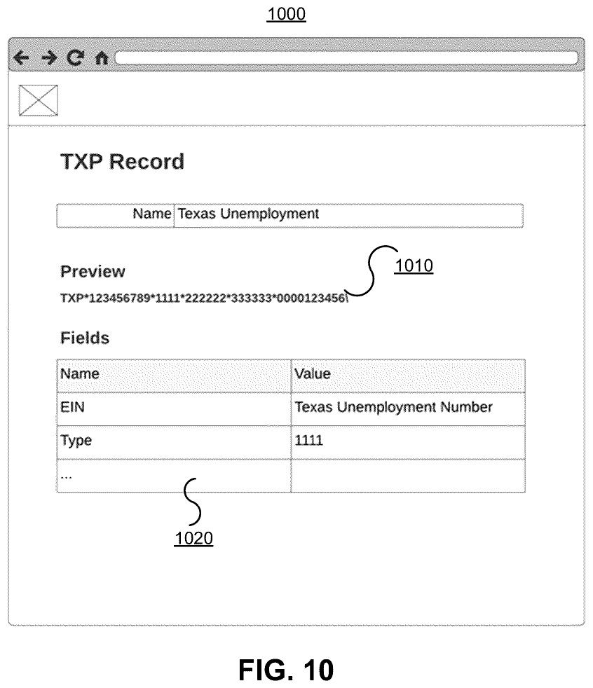

FIG. 10 illustrates an example GUI 1000 displaying a TXP record generated by applying a specific rule and a specific TXP record schema to data of an entity in accordance with one or more embodiments. The GUI 1000 displays a TXP code 1010 corresponding to a tax payment. The TXP code includes five segments of data, each corresponding to a field 1020 listed below. A user of the entity may interact with the GUI 1000 to see additional information about each field 1020. In some embodiments, when a user interacts with a segment of the TXP code (e.g., a pointing device of a user hovering over or clicking a segment of the TXP code), a corresponding field is highlighted.

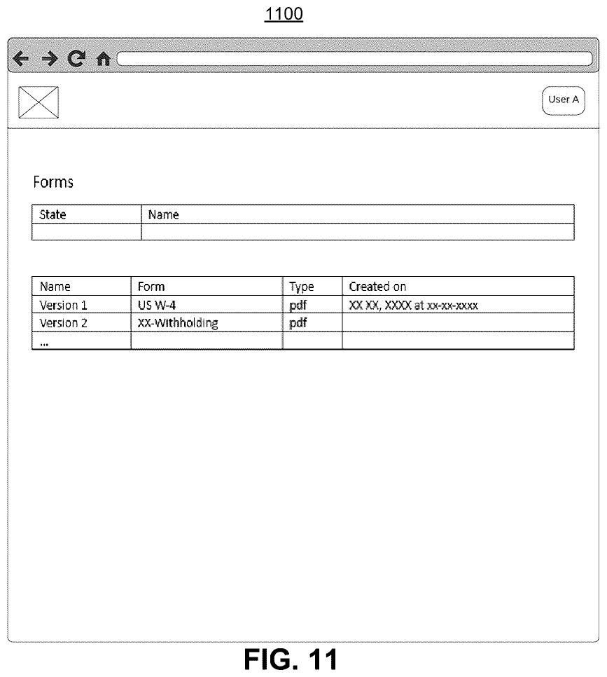

FIG. 11 illustrates an example GUI 1100 displaying a set of form schema stored in a schema database in accordance with one or more embodiments. The GUI 1100 shows unreleased form versions, and the same GUI 1100 may also show all the released form versions. The forms may be federal tax specific (e.g., US-W-4) or state tax specific (e.g., AR-941M).

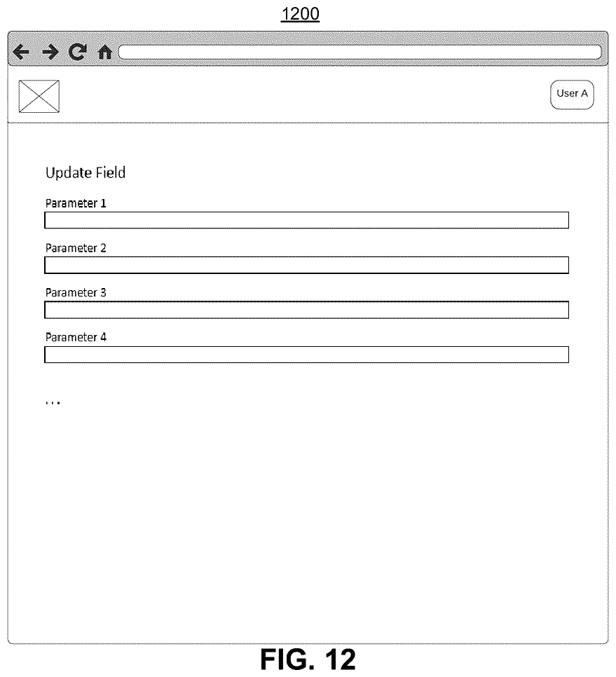

FIG. 12 illustrates an example GUI 1200 displaying a field of a form schema that may be modified in accordance with one or more embodiments. This GUI 1200 may be reached by clicking one of the forms listed in GUI 1100. The GUI 1200 shows a specific field (e.g., record identifier) in a form schema and its corresponding formats. Each field in a form schema may be viewed and/or edited.

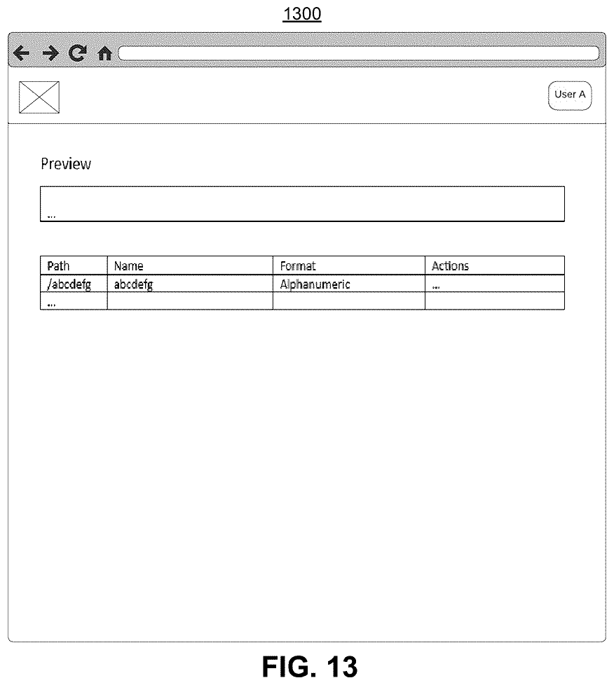

FIG. 13 illustrates an example GUI 1300 displaying a set of filing schema stored in a schema database in accordance with one or more embodiments. The GUI 1300 displays a list of filing schemas, and a user can select one of the filing schemas to preview the selected schemas. The filing schemas are in XML format. Each schema includes URLs and data structure information for filing tax-related documents electronically.

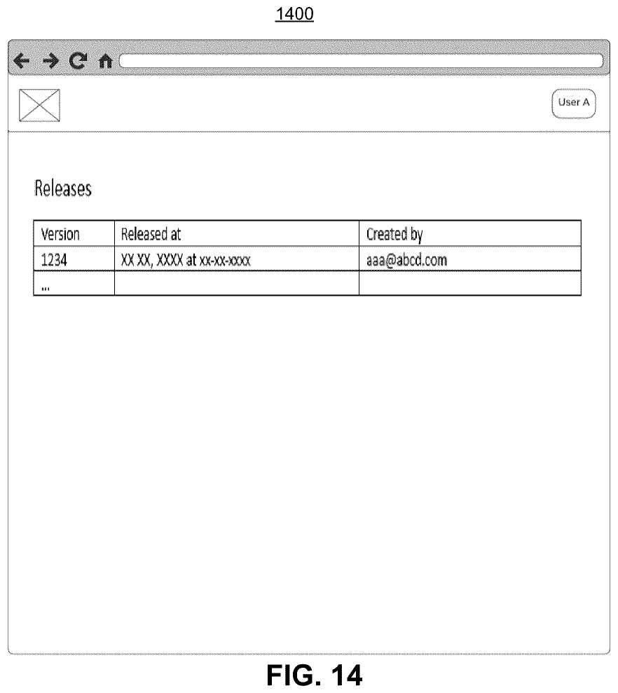

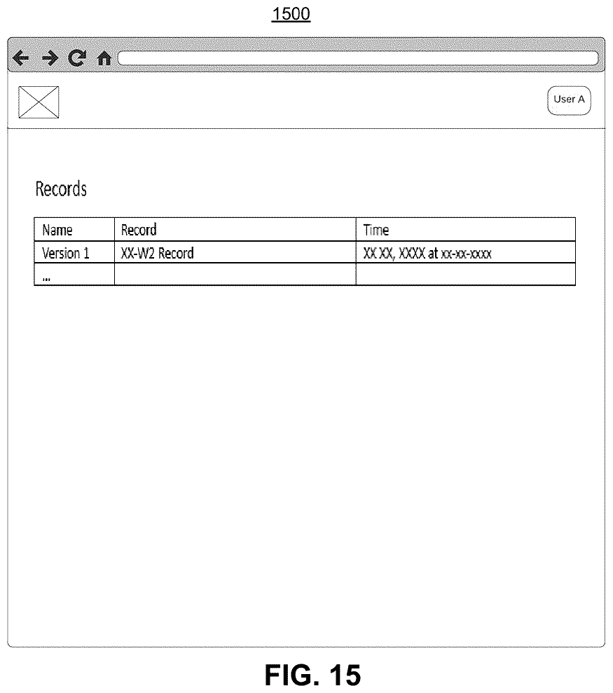

FIG. 14 illustrates an example GUI 1400 displaying different versions of a same rule in accordance with one or more embodiments. FIG. 15 illustrates an example GUI 1500 displaying different versions of a same schema in accordance with one or more embodiments. As described above, a version control engine 258 is configured to track all the versions of rules and schemas stored in the databases 220, 230. The self-healing engine 259 performs self-healing or corrective actions based on the different versions of rules or schemas tracked by the version control engine 258.

### Example Methods for Performing Network Actions

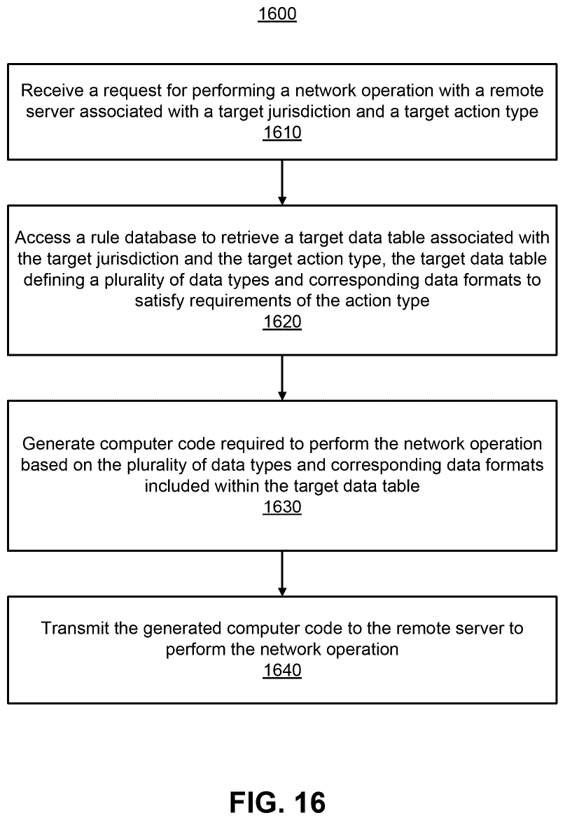

FIGS. 16-18 are flowcharts of example methods that may be performed by a central database system, e.g., central database system 110. In various embodiments, the methods include different or additional steps than those described in conjunction with FIGS. 16-18. Further, in some embodiments, the steps of the method may be performed in different orders than the order described in conjunction with FIGS. 16-18. The method described in conjunction with FIGS. 16-18 may be carried out by the central database system 110 in various embodiments, while in other embodiments, the steps of the method are performed by a combination of the central database system 110 and/or entity system 130.

FIG. 16 is a flowchart of an example method 1600 for performing a network action with a remote server associated with a target jurisdiction and a target action type. The central database system 110 receives 1610 a request to perform a network action with a remote server associated with a target jurisdiction and a target action type. For example, a request may be received from a user of an entity to set up a tax payment with a target jurisdiction, where performing the tax payment to the jurisdiction may be the target action. The remote server may be a server associated with the jurisdiction and/or a server associated with a financial institution in an ACH network. The central database system 110 accesses 1620 a rule database to retrieve a target data table associated with the target jurisdiction and the target action type. The target data table defines a plurality of data types and corresponding data formats to satisfy requirements of the action type.

The central database system 110 generates 1630 a computer code required to perform the network action based on the plurality of data types and corresponding data formats. For example, the network action may include transmitting an ACH payment to a remote server. The computer code may include TXP code appended to the ACH payment. The plurality of data types may include a taxpayer ID, a tax form code, a tax period, and an amount. For each of the data types, there may be a corresponding data format. For example, for the tax payer ID and tax form code, a numeric format with a specified number of digits might be specified. For a tax period, a quarterly filing might be specified as “Q1 2023” (for the first quarter of 2023) or “Jan. 1, 2023-Mar. 31, 2023”. A monthly period might be noted as “January 2023”. Further, the computer code may also correspond to a specified schema. For example, a TXP code may have a schema of TXP*TaxpayerID*TaxFormCode*TaxPeriod*Amount.

In some embodiments, the central database system 110 further accesses an entity database to obtain entity data associated with the data types. For example, if an entity's taxpayer ID is 123456789, the tax form code is 1120, the tax period is first quarter of 2023, and an amount is $15000, the central database system 110 obtains these data from the entity database, and applies the data formats to these data to generate a TXP code of TXP*123456789*1120*2023Q1*15000.00.

In some embodiments, the network action may also include generating and transmitting a filing form filled with entity data to a remote server. For example, a W-4 form may be filed with a tax payment. The form may also correspond to a plurality of data types and corresponding data formats. Further, in some embodiments, the form may also be associated with a schema. The schema further specifies the location of each data type positioned on a page of the form.

The central database system 110 transmits 1640 the generated computer code to the remote server to perform the network action. For example, while performing an ACH payment, the central database system 110 transmits the TXP code with the payment to the remote server. In some embodiments, the central database system 110 further transmits a form associated with the payment to a remote server associated with a jurisdiction.

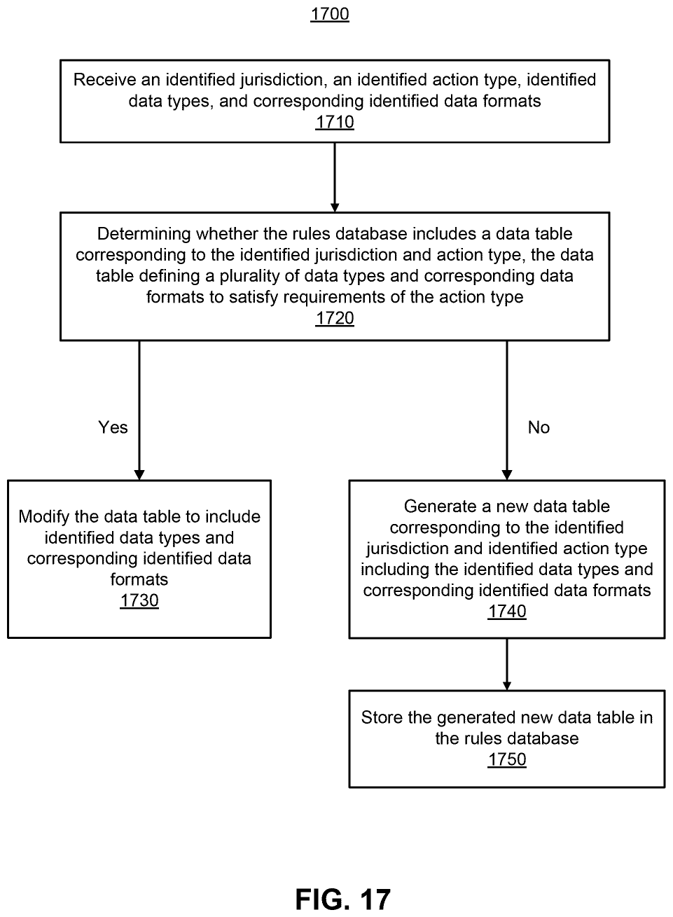

FIG. 17 is a flowchart of an example method 1700 for updating a rule database in accordance with one or more embodiments. The rule database stores a plurality of data tables. Each data table corresponds to a jurisdiction and an action type. Each data table defines a plurality of data types and corresponding data formats to satisfy requirements of the action type.

The central database system 110 receives 1710 an identified jurisdiction and an identified action type, identified data types, and corresponding identified data formats. The central database system 110 determines 1720 whether the rules database includes a data table corresponding to the identified jurisdiction and action type.

Responsive to determining that the rule database includes a data table corresponding to the identified jurisdiction and action type (Yes), the central database system 110 modifies 1730 the data table to include identified data types and corresponding identified data formats. On the other hand, responsive to determining that the rule database does not include a data table corresponding to the identified jurisdiction and action type (No), the central database system 110 generates 1740 a new data table corresponding to the identified jurisdiction and identified action type including the identified data types and corresponding identified data formats. The central database system 110 stores 1750 the generated new data table in the rule database.

In some embodiments, the new data table corresponds to the identified jurisdiction and the identified action type are stored as a new version of data table corresponding to the identified jurisdiction. A version control engine 258 keeps track of all versions of different data table over time. In some embodiments, each data table is associated with an effective date and/or an expiration date. The new version of the data table is associated with an effective date, which may also be an expiration date of the previous version of the data table.

In some embodiments, the central database system 110 determines a date associated with the network action. For example, the date may be associated with a tax period of the entity. Upon determining that the date is before the effective date, the central database system 110 generates the computer code required to perform the network action based on a previous version of the data table associated with the identified jurisdiction. On the other hand, upon determining that the date is after the effective date, the central database system 110 generates the computer code required to perform the network action based on the new version of the data table.

In some situations, the effective date of the new version of the data table may be a past date, and the update engine is configured to retroactively generate the computer code required to perform the network action based on the new version of the data table associated with the identified jurisdiction.

In some embodiments, the central database system 110 is further configured to perform a self-healing process. The self-healing process includes identifying a previously performed network action that was performed based on an out-of-date data table, and causing the interaction engine to perform a corrective network action to correct the previously performed network action, thereby effectively performing a network action retroactively based on an up-to-date target data table. For example, if the tax rate increases, any tax payments made previously based on a previous version of rule would have been calculated using the older, lower rate. A corrective action in the network might involve calculating the difference between the correct (higher) tax payment and the amount previously paid, and then executing a new tax payment to cover this difference.

In some embodiments, the central database system 110 is further configured to visualize the generated computer code. In some embodiments, the visualization (e.g., FIG. 10) presents interpretation of each of a plurality of segments of the generated computer code. For example, the TXP code, TXP*123456789*1120*2023Q1*15000.00, includes four segments, namely, taxpayer identifier segment, tax code segment, tax payment period segment, and payment amount segment. When a user interacts with a particular segment (e.g., using a pointing device to hover over or click at a particular segment), an interpretation of that segment may be presented to the user. For example, when a user interacts with (e.g., clicks) the taxpayer identifier segment, the visualization may present information related to the taxpayer identifier, such as the data field name, and data format, among others.

In some embodiments, the central database system 110 is further configured to visualize the network action associated with the target data table. In some embodiments, the visualization (e.g., FIG. 6) presents schedules (e.g., frequency) associated with the network action, and tax payment associated with the network action.

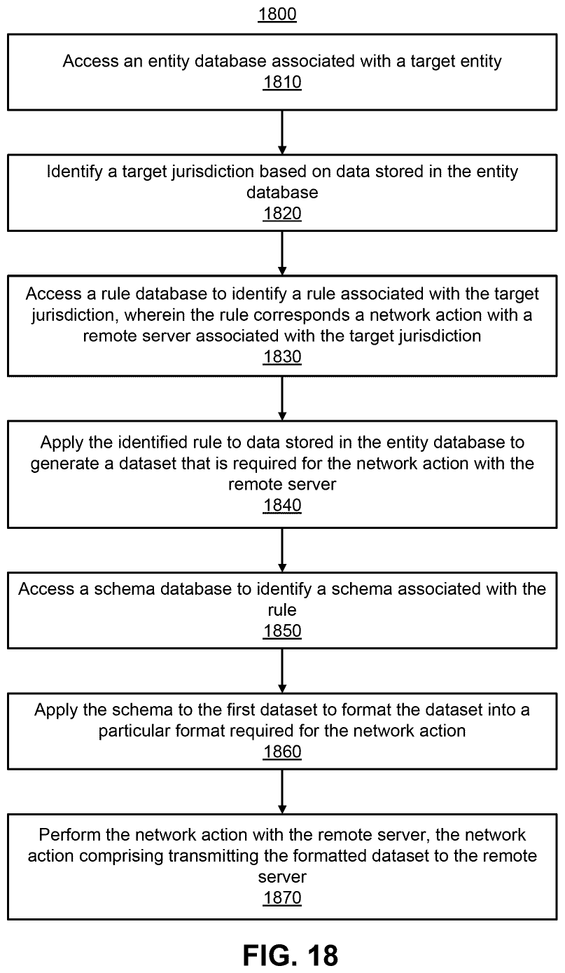

FIG. 18 is a flowchart of a method 1800 for performing network actions, in accordance with one or more embodiments. The central database system 110 accesses 1810 an entity database associated with a target entity. In some embodiments, the entity database (e.g., entity database 210) stores employee-related data within an entity. The entity database 210 also stores information related to the entity, such as taxpayer identification (e.g., EIN or TIN), and jurisdictions in which the entity is regulated.

The central database system 110 identifies 1820 a target jurisdiction based on data stored in the entity database. For example, the target jurisdiction may be one or more jurisdictions in which the entity is regulated. In some embodiments, the target jurisdiction may be identified based on employee data associated with the entity (e.g., employees'physical locations) and/or other data associated with the entity, such as the entity's physical locations.

The central database system 110 accesses 1830 a rules database to identify a rule associated with the target jurisdiction. Each rule corresponds to one or more network actions with a remote server associated with the target jurisdiction. For example, when the entity and all its employees reside in Texas, a Texas tax rule is identified, and the action corresponding to the Texas tax rule may be a tax payment and a tax form to be submitted to a remote server associated with the Texas government.

The central database system 110 applies 1840 the identified rule to data stored in the entity database to generate a dataset that is required for the network action with the remote server. For example, the tax rule requires a tax payment and/or W-4 form to include a set of data, such as taxpayer identifier, entity name, tax period, and an amount of tax payment, among others. Some portions of this dataset (e.g., entity name, taxpayer identifier) may be retrieved from the entity database; others (e.g., an amount of payment) may be computed using data retrieved from the entity database based on the tax rule. For a quarterly tax withhold for an entity, the central database system 110 may access the employee database to obtain each employee's gross pay, adjustment, and deductions, determine a tax withhold amount for each employee, and aggregate all the tax withhold amounts for all employees to generate a quarterly tax withhold for the entity.

The central database system 110 accesses 1850, a schema database, to identify a schema associated with the rule. The schema database stores a plurality of schemas corresponding to different rules. The schemas further specify a format of the network action. For example, for a tax payment, a TXP code needs to be transmitted with the tax payment to a remote server. The TXP code corresponds to a schema. Different states require different schemas for TXP code. Therefore, even if the data required for the TXP code is the same across different jurisdictions, their schemas can differ. As another example, a filing may require a submission of a tax form. Each jurisdiction may have its own tax forms. Again, even if the data required for tax filing is the same across different jurisdictions, their schemas can differ.

The central database system 110 applies 1860 the identified schema to the dataset to format the dataset into a particular format and performs 1870 the network action with the remote server. The network action includes transmitting the formatted dataset to the remote server. In some embodiments, the formatted dataset may include a TXP code and/or a tax form.

### Example Computing System

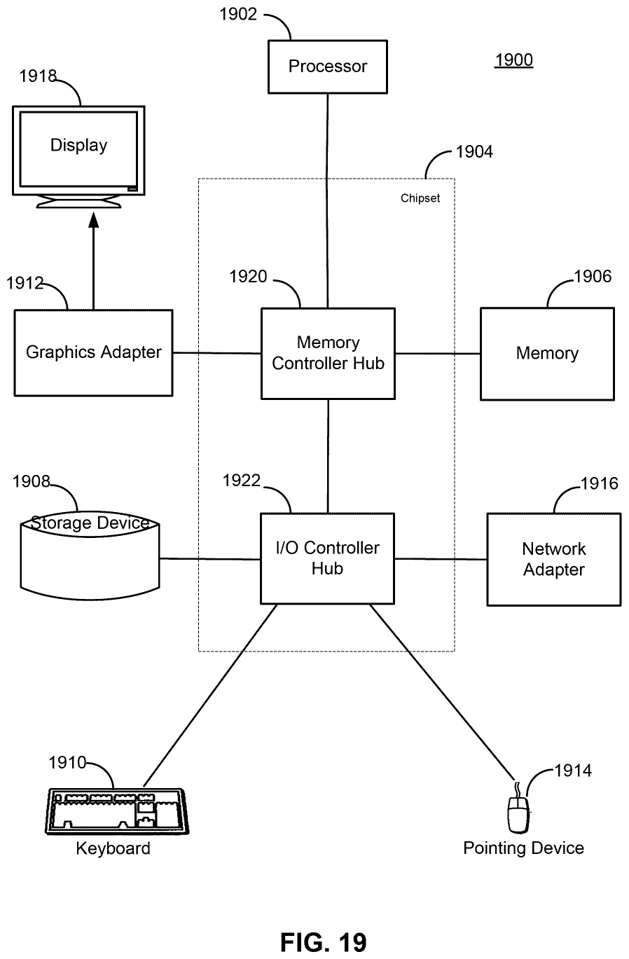

FIG. 19 is a block diagram of an example computer 1900 suitable for use in the networked computing environment 100 of FIG. 1. The computer 1900 is a computer system and is configured to perform specific functions as described herein. For example, the specific functions corresponding to central database system 110 may be configured through the computer 1900.

The example computer 1900 includes a processor system having one or more processors 1902 coupled to a chipset 1904. The chipset 1904 includes a memory controller hub 1920 and an input/output (I/O) controller hub 1922. A memory system having one or more memories 1906 and a graphics adapter 1912 are coupled to the memory controller hub 1920, and a display 1918 is coupled to the graphics adapter 1912. A storage device 1908, keyboard 1910, pointing device 1914, and network adapter 1916 are coupled to the I/O controller hub 1922. Other embodiments of the computer 1900 have different architectures.

In the embodiment shown in FIG. 19, the storage device 1908 is a non-transitory computer-readable storage medium such as a hard drive, compact disk read-only memory (CD-ROM), DVD, or a solid-state memory device. The memory 1906 holds instructions and data used by the processor 1902. The pointing device 1914 is a mouse, track ball, touchscreen, or other types of a pointing device and may be used in combination with the keyboard 1910 (which may be an on-screen keyboard) to input data into the computer 1900. The graphics adapter 1912 displays images and other information on the display 1918. The network adapter 1916 couples the computer 1900 to one or more computer networks, such as network 150.

The types of computers used by central database system 110 of FIGS. 1 through 4 can vary depending upon the embodiment and the processing power required by the entity systems 130, central database system 110, or the remote server 120. For example, the central database system 110 might include multiple blade servers working together to provide the functionality described. Furthermore, the computers can lack some of the components described above, such as keyboards 1910, graphics adapters 1912, and displays 1918.

### Additional Considerations

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

1. A database system comprising:
a rules database comprising a non-transitory computer-readable storage medium storing a plurality of data tables, each data table corresponding to a jurisdiction and an action type, each data table defining a plurality of data types and corresponding data formats to satisfy requirements of the action type;
an interaction engine comprising at least a hardware processor configured to perform one or more computer actions by:
receiving a request to perform one or more network actions, wherein each network action of the one or more network actions is associated with a target jurisdiction and a target action type, and wherein each network action comprises an execution of an operation by a server;
for each network action of the one or more network actions,
accessing the rule database to retrieve a target data table associated with the target jurisdiction and the target action type;
generating computer code required to perform the network action by encoding data associated with entities associated with the target data table based on the plurality of data types and corresponding data formats included within the target data table; and
modifying a network transmission to a remote server associated with a corresponding target jurisdiction to include the generated computer code and causing the remote server to perform the network action; and
an update engine configured to modify the rules database by:
receiving, via an interface, an identified jurisdiction, an identified action type, identified data types, and corresponding identified data formats;
in response to the rules database including a data table corresponding to the identified jurisdiction and identified action type, modifying the data table to include the identified data types and corresponding identified data formats; and
in response to the rules database not including the data table corresponding to the identified jurisdiction and identified action type, generating a new data table corresponding to the identified jurisdiction and identified action type including the identified data types and corresponding identified data formats, and storing the generated new data table in the rules database.

2. The database system of claim 1, further comprising an entity database storing data associated with a target entity, wherein the computer code is further generated based on data stored in the entity database.

3. The database system of claim 2, wherein the target entity is associated with the target jurisdiction, and the request to perform a network action is received from a client device associated with the entity.

4. The database system of claim 1, wherein the new data table corresponding to the identified jurisdiction and identified action type are stored as a new version of data table corresponding to the identified jurisdiction.

5. The database system of claim 4, wherein the new version of data table is associated with an effective time and the update engine is configured to:
determine a date associated with the network action;
responsive to determining that the date is before the effective time, generate computer code required to perform the network action based on a previous version of data table associated with the identified jurisdiction; and
responsive to determining that the date is after the effective time, generate computer code required to perform the network action based on the new version of data table associated with the identified jurisdiction.

6. The database system of claim 5, wherein the database system further comprises a self-healing engine configured to perform a self-healing process, the self-healing process comprising:
identifying a previously performed network action that was performed based on an out-of-date data table; and
causing the interaction engine to perform a corrective network action to correct the previously performed network action, thereby effectively performing a network action retroactively based on an up-to-date data table.

7. The database system of claim 1, wherein the interaction engine is further configured to visualize the generated computer code, the visualization presenting an interpretation of each of a plurality of segments of the generated computer code.

8. The database system of claim 1, wherein the interaction engine is further configured to visualize the network action, the visualization presenting a frequency associated with the network action and a payment associated with the network action.

9. A method for performing network actions, the method comprising:
accessing a rule database, storing a plurality of data tables, each data table corresponding to a jurisdiction and an action type, each data table defining a plurality of data types and corresponding data formats to satisfy requirements of the action type;
receiving a request to perform one or more network actions, wherein each network action of the one or more network actions is associated with a target jurisdiction and a target action type, and wherein each network action comprises an execution of an operation by a server;
for each network action of the one or more network actions,
accessing the rule database to retrieve a target data table associated with the target jurisdiction and the target action type;
generating computer code required to perform the network action by encoding data associated with entities associated with the target data table based on the plurality of data types and corresponding data formats included within the target data table; and
modifying a network transmission to a remote server associated with a corresponding target jurisdiction to include the generated computer code and causing the remote server to perform the network action;
receiving, via an interface, an identified jurisdiction, an identified action type, identified data types, and corresponding identified data formats;
in response to the rules database including a data table corresponding to the identified jurisdiction and identified action type, modifying the data table to include the identified data types and corresponding identified data formats; and
in response to the rules database not including the data table corresponding to the identified jurisdiction and identified action type, generating a new data table corresponding to the identified jurisdiction and identified action type including the identified data types and corresponding identified data formats, and storing the generated new data table in the rules database.

10. The method of claim 9, further comprising accessing an entity database that stores data associated with a target entity, wherein the computer code is further generated based on data stored in the entity database.

11. The method of claim 10, wherein the target entity is associated with the target jurisdiction, and the request to perform a network action is received from a client device associated with the entity.

12. The method of claim 9, wherein the new data table corresponding to the identified jurisdiction and identified action type are stored as a new version of rules corresponding to the identified jurisdiction.

13. The method of claim 12, wherein the new version of rules is associated with an effective time, and the method further comprises:
determining a date associated with the network action;
responsive to determining that the date is before the effective time, generating computer code required to perform the network action based on a previous version of data table associated with the identified jurisdiction; and
responsive to determining that the date is after the effective time, generating computer code required to perform the network action based on the new version of data table associated with the identified jurisdiction.

14. The method of claim 12, wherein the method further comprises performing self-healing, self-healing comprising:
determining that a previously performed network action was performed based on an out-of-date data table; and
performing a corrective network action to correct the previously performed network action, thereby effectively performing a network action retroactively based on an up-to-date data table.

15. The method of claim 9, wherein the method further comprises visualizing the generated computer code, the visualization presenting an interpretation of each of a plurality of sections of the generated computer code.

16. The method of claim 9, wherein the method further comprises visualizing the network action, the visualization presenting a frequency associated with the network action and a payment associated with the network action.

17. A non-transitory computer-readable storage medium having instructions encoded thereon that, when executed by a processor, cause one or more processors to:
access a rule database, storing a plurality of data tables, each data table corresponding to a jurisdiction and an action type, each data table defining a plurality of data types and corresponding data formats to satisfy requirements of the action type;
receive a request to perform one or more network actions, wherein each network action of the one or more network actions is associated with a target jurisdiction and a target action type, and wherein each network action comprises an execution of an operation by a server;
for each network action of the one or more network actions,
access the rule database to retrieve a target data table associated with the target jurisdiction and the target action type;
generate computer code required to perform the network action by encoding data associated with entities associated with the target data table based on the plurality of data types and corresponding data formats included within the target data table; and
modify a network transmission to a remote server associated with a corresponding target jurisdiction to include the generated computer code and cause the generated computer code to the remote server to perform the network action;
receive, via an interface, an identified jurisdiction, an identified action type, identified data types, and corresponding identified data formats;
in response to the rules database including a data table corresponding to the identified jurisdiction and identified action type, modify the data table to include the identified data types and corresponding identified data formats; and
in response to the rules database not including the data table corresponding to the identified jurisdiction and identified action type, generate a new data table corresponding to the identified jurisdiction and identified action type including the identified data types and corresponding identified data formats, and storing the generated new data table in the rules database.

18. The non-transitory computer-readable storage medium of claim 17, further comprising accessing an entity database that stores data associated with a target entity, wherein the computer code is further generated based on data stored in the entity database.

19. The non-transitory computer-readable storage medium of claim 17, wherein the new data table corresponding to the identified jurisdiction and identified action type are stored as a new version of data table corresponding to the identified jurisdiction.

20. The non-transitory computer-readable storage medium of claim 19, wherein the new version of data table is associated with an effective time and the instructions further cause the one or more processors:
determine a date associated with the network action;
responsive to determining that the date is before the effective date, generate computer code required to perform the network action based on a previous version of data table associated with the identified jurisdiction; and
responsive to determining that the date is after the effective time, generate computer code required to perform the network action based on the new version of data table associated with the identified jurisdiction.
